(19) United States
(12) Patent Application Publication
(10) Pub. No.: US 2024/0090507 A1
(43) Pub. Date: Mar. 21, 2024

(54) HYPOHALITE-BASED DISINFECTING COMPOSITIONS

(71) Applicant: GOJO Industries, Inc., Akron, OH (US)

(72) Inventor: Marisa Macnaughtan, Pepper Pike, OH (US)

(21) Appl. No.: 18/470,622

(22) Filed: Sep. 20, 2023

Related U.S. Application Data
(60) Provisional application No. 63/408,225, filed on Sep. 20, 2022.

(51) Int. Cl. A01N 59/08; A01N 25/30; A01P 1/00

(52) U.S. Cl. CPC A01N 59/08; A01N 25/30; A01P 1/00

(57) ABSTRACT

Hypohalite-based disinfecting compositions are provided. The hypohalite-based disinfecting compositions comprise a source of chlorine, such as sodium hypochlorite, and a blend of two or more surfactants. The inventive hypohalite-based disinfecting compositions can be delivered in liquid form or via a wipe substrate, and achieve at least a 6-log reduction in C. difficile within 2 minutes.

### CROSS-REFERENCE TO RELATED APPLICATION(S)

This application claims priority to and any benefit of U.S. Provisional Application No. 63/408,225, filed Sep. 20, 2022, the content of which is incorporated herein by reference in its entirety.

### FIELD

The present disclosure relates to hypohalite-based disinfecting compositions. More particularly, the present disclosure relates to hypohalite-based disinfecting compositions that achieve an improved rapid efficacy against microorganisms, including C. difficile.

### BACKGROUND

Bleach compositions are used by consumers for cleaning and disinfecting surfaces in the home or workplace. Such disinfection may be achieved via compositions in the form of wipes, disinfecting sprays, or bulk disinfectants. Regardless of form, users require disinfecting compositions that are safe to use, and that achieve broad-spectrum efficacy against harmful microorganisms, including pathogenic microorganisms. As such, the subject disinfecting compositions must have a low toxicity rating (e.g., be safe for the user) while providing rapid efficacy against bacteria, viruses, and fungi.

In environments specific to healthcare, serious infections are of particular concern. Such infections may be generally referred to as healthcare-associated infections (HAIs). While most types of HAIs are declining, one infection, caused by the bacteria Clostridioides difficile (i.e., Clostridium difficile) (“C. difficile” or “C. diff.”), remains at historically high levels. C. difficile is a spore-forming, gram-positive anaerobic bacillus of the human intestine and is thought to be present in 2-5% of the adult population. Pathogenic C. difficile strains produce multiple toxins, the most well-characterized of which are enterotoxin (C. difficile toxin A) and cytotoxin (C. difficile toxin B), both of which can produce diarrhea and inflammation in infected patients. The emergence of a new, highly toxic strain of C. difficile, resistant to fluoroquinolone antibiotics such as ciprofloxacin and levofloxacin, has also been reported. C. difficile infections affect approximately half a million people per year in the United States.

Conventional bleach formulations include a source of chlorine, e.g., sodium hypochlorite, as the active ingredient diluted within a buffered liquid composition. While various bleach formulations have been found to provide a reduction against C. difficile spores on surfaces, the bleach formulations known in the art have been unable to meet desired standards of rapid efficacy against C. difficile spores. Specifically, a need exists for hypohalite-based disinfecting compositions that are delivered either in liquid form or via a wipe substrate, which achieve at least a 6-log reduction in C. difficile within 2 minutes or less. Moreover, in addition to the rapid efficacy, it is desirable for such compositions to maintain or exceed the current market demand for shelf life, human safety, and surface compatibility for bleach compositions.

### SUMMARY

The general inventive concepts are directed to hypohalite-based disinfecting compositions comprising greater than 0.5 wt.% of a hypohalite ingredient and a particular surfactant blend. The surfactant blend comprises a first surfactant and a second surfactant, wherein the second surfactant has an average tail chain length value that is different than the first surfactant. The hypohalite-based disinfecting composition exhibits at least a 6-log reduction in C. diff. within 2 minutes.

### DESCRIPTION OF THE FIGURES

The advantages of the inventive concepts will be apparent upon consideration of the following detailed disclosure, especially when taken in conjunction with the accompanying drawings wherein:

FIG. 1 is a line plot showing the surface tension of otherwise identical hypohalite-based disinfecting compositions comprising varying levels of sodium lauryl sulfate and myristamine oxide (“SLS/MO”) surfactant blends.

### DETAILED DESCRIPTION

Disclosed herein are hypohalite-based disinfecting compositions. While the present disclosure describes certain embodiments of the hypohalite-based disinfecting compositions in detail, the present disclosure is to be considered exemplary and is not intended to be limited to the disclosed embodiments.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

The hypohalite-based disinfecting compositions of the present disclosure can comprise, consist of, or consist essentially of the essential elements of the disclosure as described herein, as well as any additional or optional element described herein, or which is otherwise useful in disinfecting applications.

All percentages, parts, and ratios as used herein are by weight of the total formulation, unless otherwise specified.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

The general inventive concepts relate to hypohalite-based disinfecting compositions. More particularly, the inventive concepts relate to sodium hypochlorite compositions containing a blend of two or more surfactants. In accordance with the present disclosure, the surfactant blend comprises at least two surfactants having different average tail lengths, i.e., a tail chain length distribution with a different average number of carbon units. The inventive hypohalite-based disinfecting compositions achieve at least a 6-log reduction in C. difficile within 2 minutes.

In accordance with the present disclosure, the hypohalite-based disinfecting compositions are characterized by the presence of an oxidant ingredient that forms free halite ions, i.e., a hypohalite ingredient. In accordance with the present disclosure, the oxidant ingredient comprises a source of free chlorine ions including, without limitation, chlorine dioxide decahydrate, sodium hypochlorite pentahydrate, chlorinated trisodium phosphate, an alkali metal hypochlorite or an alkaline earth metal hypochlorite selected from the group consisting of sodium, potassium, magnesium, lithium, or calcium hypochlorites, or mixtures thereof. In some embodiments, the oxidant ingredient comprises, or consists of, hypochlorous acid or a salt or derivative thereof. In some embodiments, the oxidant ingredient comprises a precursor to hypohalite salts, hypohalous acid or other halite ions. In some embodiments, the precursor is an organic chloramine complex, including, without limitation, dichloroisocyanuric acid, dichloroisocyanurate salt, trichloroisocyanuric acid, 1,3 -dichloro-5,5-dimethylhydantoin, 1-bromo-3-chloro-5,5-dimethylhydantoins, 1,3-dibromo-5,5-dimethylhydantoin, trichloromelamine, and N-chloro-aryl-sulfonamides. In some embodiments, the oxidant ingredient comprises, or consists of, a hypochlorite. In some embodiments, the oxidant ingredient is selected from the group consisting of sodium hypochlorite and potassium hypochlorite. In some embodiments, the oxidant ingredient comprises, or consists of, sodium hypochlorite.

In accordance with the present disclosure, the hypohalite-based disinfecting composition comprises greater than 0.5 wt. % of a hypohalite ingredient, based upon the total weight of the hypohalite-based disinfecting composition. In some embodiments, the hypohalite-based disinfecting composition comprises 0.55 wt.% or greater of a hypohalite ingredient, including 0.6 wt. % or greater, including 0.65 wt. % or greater, including 0.7 wt. % or greater, including 0.75 wt. % or greater, based upon the total weight of the hypohalite-based disinfecting composition. In some embodiments, the hypohalite-based disinfecting composition comprises from greater than 0.5 to 2 wt. % of a hypohalite ingredient, including from 0.55 to 1.9 wt. %, including from 0.6 to 1.8 wt. %, including from 0.65 to 1.5 wt. %, including from 0.7 to 1.3 wt. %, including from 0.75 to 1.2 wt. %, based upon the total weight of the hypohalite-based disinfecting composition. The concentration of the hypohalite ingredient may also be expressed in terms of parts per million (ppm) within the hypohalite-based disinfecting composition. Accordingly, in some embodiments, the hypohalite-based disinfecting composition comprises greater than 5,000 ppm of the hypohalite ingredient, including 5,500 ppm or greater, including 6,000 ppm or greater, including 6,500 ppm or greater, including 7,000 ppm or greater, including 7,500 ppm or greater. In some embodiments, the hypohalite-based disinfecting composition comprises from greater than 5,000 to 20,000 ppm of the hypohalite ingredient, including from 5,500 to 19,000 ppm, including from 6,000 to 18,000 ppm, including from 6,500 to 15,000 ppm, including from 7,000 to 13,000 ppm, including from 7,500 to 12,000 ppm.

In accordance with the present disclosure, the hypohalite-based disinfecting compositions comprise a surfactant blend, or said otherwise, a blend of two or more different surfactants. In some embodiments, the surfactant blend consists of two surfactants, i.e., a first surfactant and a second surfactant. In some embodiments, the surfactant blend consists of three surfactants.

In accordance with the present disclosure, the hypohalite-based disinfecting composition comprises 0.1 wt. % or less of the surfactant blend, based upon the total weight of the hypohalite-based disinfecting composition. In some embodiments, the hypohalite-based disinfecting composition comprises 0.09 wt. % or less of the surfactant blend, including 0.075 wt. % or less, including 0.06 wt. % or less, including 0.05 wt. % or less, including 0.03 wt. % or less, based upon the total weight of the hypohalite-based disinfecting composition. In some embodiments, the hypohalite-based disinfecting composition comprises from 0.005 to 0.1 wt. % of the surfactant blend, including from 0.01 to 0.09 wt. %, including from 0.01 to 0.075 wt. %, including from 0.01 to 0.05 wt. %, including from 0.01 to 0.04 wt. %, including from 0.01 to 0.03 wt. %, based upon the total weight of the hypohalite-based disinfecting composition. As set forth in this paragraph, the “wt. % of the surfactant blend” means the total concentration of the surfactants within the hypohalite-based disinfecting composition, based upon the total weight of the hypohalite-based disinfecting composition. The concentration of the surfactant blend may also be expressed in terms of parts per million (ppm) within the hypohalite-based disinfecting composition. Accordingly, in some embodiments, the hypohalite-based disinfecting composition comprises 1,000 ppm or less of the surfactant blend, including 900 ppm or less, including 750 ppm or less, including 600 ppm or less, including 500 ppm or less, including 300 ppm or less. In some embodiments, the hypohalite-based disinfecting composition comprises from 50 to 1,000 ppm of the surfactant blend, including from 100 to 900 ppm, including from 100 to 750 ppm, including from 100 to 500 ppm, including from 100 to 400 ppm, including from 100 to 300 ppm.

In some embodiments, the surfactant blend comprises at least two surfactants having different average tail lengths, i.e., a tail chain length distribution with a different average number of carbon units. In some embodiments, the surfactant blend consists of two surfactants, wherein the two surfactants have different average tail lengths. In some embodiments, the surfactant blend comprises at least two surfactants having different head groups. In some embodiments, the surfactant blend consists of two surfactants, wherein the two surfactants have different head groups. In some embodiments, the surfactant blend consists of two surfactants, wherein the two surfactants have different average tail lengths and different head groups. In some embodiments, the surfactant blend consists of two surfactants, wherein the first surfactant has an average tail chain length of a C8 to C18 value and the second surfactant has an average tail chain length of a different C8 to C18 value than the first surfactant. In some embodiments, the surfactant blend consists of two surfactants, wherein the first surfactant has an average tail chain length of a C10 to C16 value and the second surfactant has an average tail chain length of a different C10 to C16 value than the first surfactant. In some embodiments, the surfactant blend consists of two surfactants, wherein the first surfactant has an average tail chain length of a C12 to C14 value and the second surfactant has an average tail chain length of a different C12 to C14 value than the first surfactant. In some embodiments, the surfactant blend consists of two surfactants, wherein the first surfactant has an average tail chain length of C12 and the second surfactant has an average tail chain length of C14. One surprising feature of the present invention is the enhanced efficacy provided by the blend of two surfactants having different average tail lengths, i.e., a tail chain length distribution with a different average number of carbon units. Specifically, the combination of sodium lauryl sulfate, having a C12 average tail length, and myristamine oxide, having a C14 average tail length, has been found to have a synergistic effect, i.e., more than just an additive effect, on the efficacy of the inventive composition.

In accordance with the present disclosure, the surfactant blend comprises anionic, zwitterionic, or nonionic surfactants. The term “amphoteric” surfactant is often used interchangeably with the term “zwitterionic” surfactant, i.e. each term has the identical meaning of surfactants having both cationic and anionic centers attached to the same molecule. In some embodiments, the surfactant blend comprises at least one anionic surfactant and at least one surfactant comprising a zwitterionic or a nonionic surfactant. In some embodiments, the surfactant blend consists of two surfactants, wherein the first surfactant is an anionic surfactant and the second surfactant is selected from the group consisting of a zwitterionic or a nonionic surfactant. In some embodiments, the surfactant blend consists of two surfactants, wherein the first surfactant is an anionic surfactant and the second surfactant is a zwitterionic surfactant. In some embodiments, the surfactant blend consists of two surfactants, wherein the first surfactant is a non-ionic surfactant and the second surfactant is a zwitterionic surfactant. In some embodiments, the surfactant blend consists of two different zwitterionic surfactants. In some embodiments, the surfactant blend consists of two different anionic surfactants. In some embodiments, the hypohalite-based disinfecting compositions are devoid of cationic surfactants. In some embodiments, the hypohalite-based disinfecting compositions are devoid of quaternary ammonium compounds, commonly known in the art as “quats,” including, without limitation, quaternary ammonium chlorides. In some embodiments, the hypohalite-based disinfecting compositions are devoid of nonionic surfactants.

In accordance with the present disclosure, the surfactant blend may comprise one or more anionic surfactants. In some embodiments, the anionic surfactant may comprise one or more sulfates, including, but not limited to, sodium alkyl sulfate, sodium octyl sulfate, sodium nonyl sulfate, sodium decyl sulfate, sodium undecyl sulfate, sodium lauryl sulfate, sodium dodecyl sulfate, sodium tridecyl sulfate, sodium tetradecyl sulfate, sodium myristyl sulfate, sodium pentadecyl sulfate, sodium hexadecyl sulfate, sodium heptadecyl sulfate, sodium octodecyl sulfate, potassium lauryl sulfate, ammonium lauryl sulfate, magnesium lauryl sulfate, sodium 2-ethylhexyl sulfate, or any other branched alkyl groups or salts; one or more carboxylates, including, but not limited to, sodium caprylate, sodium pelargonate, sodium caprate, sodium undecylate, sodium laurate, sodium tridecylate, sodium myristate, sodium pentadecylate, sodium palmitate, sodium margarate, sodium stearate, or other salts (including, put not limited to, potassium, barium, calcium, magnesium, ammonium, and tetraalkyl ammoniums); one or more sulfonates, including, but not limited to sodium nonanoyl oxybenzene sulfonate, sodium dodecylbenzene sulfonate, alpha olefin sulfonate, alkyl sulfonates, alkyl/aryl sulfonates, alkyldiphenyloxide disulfonates, sulphated esters, sulphated alkanolamides, and alkylphenols; one or more phosphates, including, but not limited to, alkyl-aryl ether phosphates, alkyl ether phosphates; sulfosuccinates; sarcosinates; sodium lauryl sarcosinate, alkyl-ether sulfates; sodium laureth sulfate, ammonium laureth sulfate, magnesium laureth sulfate, sodium myreth sulfate; or mixtures thereof. In some embodiments, the anionic surfactant comprises, or consists of, one or more of sodium dodecyl sulfate, sodium tetradecyl sulfate, sodium laurate, sodium myristate, or combinations thereof. In some embodiments, the anionic surfactant comprises, or consists of, sodium lauryl sulfate (“SLS”).

In accordance with the present disclosure, the hypohalite-based disinfecting composition comprises less than 0.07 wt. % of one or more anionic surfactants, based upon the total weight of the hypohalite-based disinfecting composition. In some embodiments, the hypohalite-based disinfecting composition comprises 0.065 wt. % or less of one or more anionic surfactants, including 0.06 wt. % or less, including 0.05 wt. % or less, including 0.04 wt. % or less, including 0.03 wt. % or less, based upon the total weight of the hypohalite-based disinfecting composition. In some embodiments, the hypohalite-based disinfecting composition comprises from 0.001 to 0.07 wt. % of one or more anionic surfactants, including from 0.002 to 0.06 wt. %, including from 0.003 to 0.05 wt. %, including from 0.004 to 0.04 wt. %, including from 0.005 to 0.035 wt. %, including from 0.01 to 0.03 wt. %, based upon the total weight of the hypohalite-based disinfecting composition. The concentration of the one or more anionic surfactants may also be expressed in terms of parts per million (ppm) within the hypohalite-based disinfecting composition. Accordingly, in some embodiments, the hypohalite-based disinfecting composition comprises less than 700 ppm of one or more anionic surfactants, including 650 ppm or less, including 600 ppm or less, including 500 ppm or less, including 400 ppm or less, including 300 ppm or less. In some embodiments, the hypohalite-based disinfecting composition comprises from 10 to 700 ppm of one or more anionic surfactants, including from 20 to 600 ppm, including from 30 to 500 ppm, including from 40 to 400 ppm, including from 50 to 350 ppm, including from 100 to 300 ppm.

In accordance with the present disclosure, the hypohalite-based disinfecting composition comprises less than 0.07 wt. % of sodium lauryl sulfate (“SLS”), based upon the total weight of the hypohalite-based disinfecting composition. In some embodiments, the hypohalite-based disinfecting composition comprises 0.065 wt. % or less of SLS, including 0.06 wt. % or less, including 0.05 wt. % or less, including 0.04 wt. % or less, including 0.03 wt. % or less, based upon the total weight of the hypohalite-based disinfecting composition. In some embodiments, the hypohalite-based disinfecting composition comprises from 0.001 to 0.07 wt. % of SLS, including from 0.002 to 0.06 wt. %, including from 0.003 to 0.05 wt. %, including from 0.004 to 0.04 wt. %, including from 0.005 to 0.035 wt. %, including from 0.01 to 0.03 wt. %, based upon the total weight of the hypohalite-based disinfecting composition. The concentration of the SLS surfactant may also be expressed in terms of parts per million (ppm) within the hypohalite-based disinfecting composition. Accordingly, in some embodiments, the hypohalite-based disinfecting composition comprises less than 700 ppm of SLS, including 650 ppm or less, including 600 ppm or less, including 500 ppm or less, including 400 ppm or less, including 300 ppm or less. In some embodiments, the hypohalite-based disinfecting composition comprises from 10 to 700 ppm of SLS, including from 20 to 600 ppm, including from 30 to 500 ppm, including from 40 to 400 ppm, including from 50 to 350 ppm, including from 100 to 300 ppm.

In accordance with the present disclosure, the surfactant blend may comprise one or more zwitterionic surfactants. In some embodiments, the zwitterionic surfactant may comprise one or more of C8-C18 alkyl amine oxides, such as dimethyl decylamine oxide, dimethyl lauramine oxide, dimethyl myristyl amine oxide, lauryl/myristyl amidopropyl amine oxide, decylamine oxide, or cocamidopropylamine oxide; one or more C8-C18 betaines, such as cocobetaine; one or more C12 betaines; one or more sultaines, or combinations thereof. In some embodiments, the hypohalite-based disinfecting composition is devoid of lauramine oxide. In some embodiments, the zwitterionic surfactant comprises, or consists of, myristamine oxide.

In accordance with the present disclosure, the hypohalite-based disinfecting composition comprises less than 0.03 wt. % of one or more zwitterionic surfactants, based upon the total weight of the hypohalite-based disinfecting composition. In some embodiments, the hypohalite-based disinfecting composition comprises 0.025 wt. % or less of one or more zwitterionic surfactants, including 0.02 wt. % or less, including 0.015 wt. % or less, including 0.0125 wt. % or less, including 0.01 wt. % or less, based upon the total weight of the hypohalite-based disinfecting composition. In some embodiments, the hypohalite-based disinfecting composition comprises from 0.001 to 0.03 wt. % of one or more zwitterionic surfactants, including from 0.002 to 0.025 wt. %, including from 0.0025 to 0.02 wt. %, including from 0.003 to 0.015 wt. %, including from 0.005 to 0.0125 wt. %, including from 0.005 to 0.01 wt. %, based upon the total weight of the hypohalite-based disinfecting composition. The concentration of the one or more zwitterionic surfactants may also be expressed in terms of parts per million (ppm) within the hypohalite-based disinfecting composition. Accordingly, in some embodiments, the hypohalite-based disinfecting composition comprises less than 300 ppm of one or more zwitterionic surfactants, including 250 ppm or less, including 200 ppm or less, including 150 ppm or less, including 125 ppm or less, including 100 ppm or less. In some embodiments, the hypohalite-based disinfecting composition comprises from 10 to 300 ppm of one or more zwitterionic surfactants, including from 20 to 250 ppm, including from 25 to 200 ppm, including from 30 to 150 ppm, including from 50 to 125 ppm, including from 50 to 100 ppm.

In accordance with the present disclosure, the hypohalite-based disinfecting composition comprises less than 0.03 wt. % of myristamine oxide, based upon the total weight of the hypohalite-based disinfecting composition. In some embodiments, the hypohalite-based disinfecting composition comprises 0.025 wt. % or less of myristamine oxide, including 0.02 wt. % or less, including 0.015 wt. % or less, including 0.0125 wt. % or less, including 0.01 wt. % or less, based upon the total weight of the hypohalite-based disinfecting composition. In some embodiments, the hypohalite-based disinfecting composition comprises from 0.001 to 0.03 wt. % of myristamine oxide, including from 0.002 to 0.025 wt. %, including from 0.0025 to 0.02 wt. %, including from 0.003 to 0.015 wt. %, including from 0.005 to 0.0125 wt. %, including from 0.005 to 0.01 wt. %, based upon the total weight of the hypohalite-based disinfecting composition. The concentration of the myristamine oxide surfactant may also be expressed in terms of parts per million (ppm) within the hypohalite-based disinfecting composition. Accordingly, in some embodiments, the hypohalite-based disinfecting composition comprises less than 300 ppm of myristamine oxide, including 250 ppm or less, including 200 ppm or less, including 150 ppm or less, including 100 ppm or less. In some embodiments, the hypohalite-based disinfecting composition comprises from 10 to 300 ppm of myristamine oxide, including from 20 to 250 ppm, including from 25 to 200 ppm, including from 30 to 150 ppm, including from 50 to 125 ppm, including from 50 to 100 ppm.

In some embodiments of the present disclosure, the surfactant blend may comprise one or more nonionic surfactants including, but not limited to, ethoxylates, alkylphenol ethoxylates, ethoxylated amines, propoxylates, propoxylate/ethoxylates, or combinations thereof. In some embodiments of the present disclosure, the hypohalite-based disinfecting composition is devoid of nonionic surfactants.

In accordance with the present disclosure, the hypohalite-based disinfecting compositions comprise a surfactant blend having a particular molar ratio of surfactants. In some embodiments, the surfactant blend consists of two surfactants, wherein the first surfactant is an anionic surfactant, and the second surfactant is a zwitterionic surfactant. In some embodiments, the molar ratio of anionic surfactant to zwitterionic surfactant (i.e., [anionic surfactant]:[zwitterionic surfactant]) is from 10:1 to 1:10, including from 9:1 to 1:9, including from 7:1 to 1:7, including from 5:1 to 1:5, including from 4:1 to 1:4, including from 3:1 to 1:3. In some embodiments, the surfactant blend consists of a blend of sodium lauryl sulfate (“SLS”) and myristamine oxide (“MO”), wherein the molar ratio of sodium lauryl sulfate to myristamine oxide (i.e., [SLS]:[MO] is from 10:1 to 1:10, including from 9:1 to 1:9, including from 7:1 to 1:7, including from 5:1 to 1:5, including from 4:1 to 1:4, including from 3:1 to 1:3.

In accordance with the present disclosure, the hypohalite-based disinfecting composition may comprise a particular weight ratio of surfactant to hypohalite ingredient. In some embodiments, the weight ratio of total surfactants in the composition to the hypohalite ingredient (i.e., [wt. % surfactant blend]:[wt. % hypohalite ingredient]), based on the total weight of the hypohalite-based disinfecting composition, is below 1:1, including 0.95:1 or less, including 0.9:1 or less, including from 0.01:1 to 0.95:1, including from 0.01:1 to 0.5:1, including from 0.025:1 to 0.035:1. In some embodiments, the surfactant blend comprises a blend of sodium lauryl sulfate and myristamine oxide, and the hypohalite ingredient comprises sodium hypochlorite, wherein the weight ratio of surfactant blend to sodium hypochlorite, based on the total weight of the hypohalite-based disinfecting composition is below 1:1, including 0.95:1 or less, including 0.9:1 or less, including from 0.01:1 to 0.95:1, including from 0.01:1 to 0.5:1, including from 0.025:1 to 0.035:1.

In accordance with the present disclosure, the hypohalite-based disinfecting compositions comprise one or more buffers. In some embodiments, the hypohalite-based disinfecting compositions comprise, or consist of, two buffers. Exemplary buffers include, but are not limited to, carbonates, bicarbonates, silicates, boric acid, borates, phosphates, phosphoric acid, sulfuric acid, sodium bisulfate, hydrochloric acid, sodium hydroxide, monocarboxylic acid, polycarboxylic acid, polyphosphates or polyphosphoric acids, salts of any of the foregoing, derivatives of any of the foregoing, or mixtures of any of the foregoing. In some embodiments, the one or more buffers comprise alkali metal salts of carbonates, bicarbonates, polycarbonates, phosphates, phosphoric acid, polyphosphates, polyphosphoric acid, or mixtures of any of the foregoing.

In accordance with the present disclosure, the hypohalite-based disinfecting composition comprises from 0.001 to 1 wt. % of the one or more buffers, including from 0.002 to 0.9 wt. %, including from 0.005 to 0.8 wt. %, including from 0.005 to 0.75 wt. %, including from 0.015 to 0.7 wt. %, including from 0.02 to 0.6 wt. %, based upon the total weight of the hypohalite-based disinfecting composition. The concentration of the one or more buffers may also be expressed in terms of parts per million (ppm) within the hypohalite-based disinfecting composition. Accordingly, in some embodiments, the hypohalite-based disinfecting composition comprises from 10 to 10,000 ppm of the one or more buffers, including from 20 to 9,000 ppm, including from 50 to 8,000 ppm, including from 50 to 7,500 ppm, including from 150 to 7,000 ppm, including from 200 to 6,000 ppm.

In accordance with the present disclosure, the hypohalite-based disinfecting composition may comprise one or more alkaline pH adjusting agents in addition to the one or more buffers. In general, the term “alkaline pH adjusting agent” as used herein refers to any compound that interacts with water to create an OH⁽⁻⁾ ion. Suitable alkaline pH adjusting agents include, but are not limited to, hydroxides such as sodium hydroxide, potassium hydroxide, calcium hydroxide, lithium hydroxide, magnesium hydroxide, ammonium hydroxide, tetraalkylammonium hydroxide, tetraarylammonium hydroxide, choline hydroxide, and combinations thereof; metal oxides such as calcium oxide, magnesium oxide, and sodium oxide; sodium alkoxides, potassium alkoxides, sodium aryloxides, and like compounds having a sodium, potassium, lithium, calcium or magnesium cation. In some embodiments, the one or more alkaline pH adjusting agents comprise, or consist of, one or more of potassium hydroxide and sodium hydroxide. In some embodiments, the one or more alkaline pH adjusting agents comprise, or consist of, sodium hydroxide. In other embodiments, the hypohalite-based disinfecting composition is devoid of pH adjusting agents other than the inventive blend of buffers. In some embodiments, the hypohalite-based disinfecting composition is devoid of added hydroxides. In some embodiments, the hypohalite-based disinfecting composition is devoid of sodium hydroxide and potassium hydroxide.

In accordance with the present disclosure, the hypohalite-based disinfecting compositions have a pH of greater than 9, including greater than 9.5, including greater than 10, including greater than 10.5, including greater than 11, including greater than 11.5. In some embodiments, the hypohalite-based disinfecting compositions have a pH of less than 14, including less than 13.5, including less than 13, including less than 12.5, including less than 12, including less than 11. In some embodiments, the hypohalite-based disinfecting compositions have a pH of from 9 to 13, including from 9 to 12, including from 9.5 to less than 12, including from 9.6 to 11.7, including from 9.6 to 11.6, including from 10 to 11.5.

In accordance with the present disclosure, the hypohalite-based disinfecting compositions may comprise a number of optional ingredients comprising corrosion inhibitors, hydrotropes, or chaotropes. Exemplary optional ingredients include, but are not limited to, sodium silicate, sodium or potassium benzoate, zinc salts, sodium or zinc polyacrylates, calcium salts, magnesium salts, sodium xylene sulfonate, sodium benzene sulfonate, sodium toluene sulfonate, sodium alkonates, colatrope, or phosphate esters. In some embodiments, the hypohalite-based disinfecting compositions are devoid of added corrosion inhibitors, devoid of added hydrotropes, or devoid of added chaotropes. In some embodiments, the hypohalite-based disinfecting compositions are devoid of quaternary ammonium compounds. In some embodiments, the hypohalite-based disinfecting compositions are devoid of silicate ingredients. In some embodiments, the hypohalite-based disinfecting compositions are devoid of sulfonate ingredients. In some embodiments, the hypohalite-based disinfecting compositions are devoid of small molecule sulfonate ingredients. In some embodiments, the hypohalite-based disinfecting compositions are devoid of sodium xylene sulfonate. In some embodiments, the hypohalite-based disinfecting compositions may comprise one or more fragrance ingredients.

In accordance with the present disclosure, the hypohalite-based disinfecting compositions comprise water quantum sufficit (q.s.). In some embodiments, the hypohalite-based disinfecting compositions comprise at least 80 wt. % water. In some embodiments, the hypohalite-based disinfecting compositions comprise at least 90 wt. % water. In some embodiments, the hypohalite-based disinfecting compositions comprise at least 95 wt. % water. In some embodiments, the hypohalite-based disinfecting compositions comprise at least 96 wt. % water. In some embodiments, the hypohalite-based disinfecting compositions comprise at least 97 wt. % water. In some embodiments, the hypohalite-based disinfecting compositions comprise at least 98 wt. % water. In some embodiments, the hypohalite-based disinfecting compositions comprise from 80 to 99 wt. % water. In some embodiments, the hypohalite-based disinfecting compositions comprise from 90 to 99 wt. % water. In some embodiments, the hypohalite-based disinfecting compositions comprise from 90 to 98 wt. % water. In some embodiments, the hypohalite-based disinfecting compositions comprise from 95 to 98 wt. % water. In some embodiments, the hypohalite-based disinfecting compositions comprise from 96 to 98 wt. % water. In some embodiments, the hypohalite-based disinfecting compositions comprise from 97 to 98 wt. % water. More or less water may be required in certain instances, depending particularly on other ingredients and/or the amounts thereof employed.

The United States Environmental Protection Agency (EPA) publishes guidance regarding the efficacy of a composition against C. difficile spores. Specifically, the EPA publishes the “Standard Operating Procedure for Quantitative Disk Carrier Test Method (QCT-2) Modified for Testing Antimicrobial Products Against Spores of Clostridium difficile (ATCC 43598) on Inanimate, Hard, Non-porous Surfaces” (SOP Number: MB-31-03) (Date Revised: Jun. 12, 2014). The EPA regulates that the scope of the QCT-2 quantitative method is to evaluate the sporicidal efficacy of liquid disinfectants against C. diff. spores, based upon the ASTM Standard E2197-11. Specifically, the published EPA guidance teaches that the QCT-2 test method is used to generate the log reduction values of viable spores of C. diff. Unless otherwise specified, the term “log reduction” as used herein in accordance with EPA standards refers to a log 10 average reduction. Likewise in accordance with the noted EPA standards, the log reductions set forth in the instant disclosure are based upon the application of 50 μL of solution under the QCT-2 protocol.

In accordance with the present disclosure, the inventive hypohalite-based disinfecting compositions provide at least a 3-log reduction in C. difficile spores within 10 minutes, including within 5 minutes, including within 3 minutes, including within 2 minutes, including within less than 2 minutes, including within 110 seconds, including within 105 seconds, including within 90 seconds, including within 80 seconds, including within 60 seconds. In accordance with the present disclosure, the inventive hypohalite-based disinfecting compositions provide at least a 5-log reduction in C. difficile spores within 10 minutes, including within 5 minutes, including within 3 minutes, including within 2 minutes, including within less than 2 minutes, including within 110 seconds, including within 105 seconds, including within 90 seconds, including within 80 seconds, including within 60 seconds. In accordance with the present disclosure, the inventive hypohalite-based disinfecting compositions provide at least a 6-log reduction in C. difficile spores within 10 minutes, including within 5 minutes, including within 3 minutes, including within 2 minutes, including within less than 2 minutes, including within 110 seconds, including within 105 seconds, including within 90 seconds, including within 80 seconds, including within 60 seconds.

The ability of the inventive hypohalite-based disinfecting compositions to provide at least a 3-log reduction, at least a 5-log reduction, and even as high as at least a 6-log reduction, in C. difficile spores within 2 minutes, or less, is a particularly surprising feature of the instant invention. A 6-log reduction correlates to a 99.9999% reduction in C. difficile spores. Without being bound by theory, it has been surprisingly found that intentionally blending two or more surfactants having different average tail lengths leads to the superior rapid efficacy against C. diff. of the composition as compared to an otherwise identical composition comprising either one surfactant, or else two or more surfactants having identical average tail lengths.

In addition to efficacy against C. difficile spores, the hypohalite-based disinfecting compositions disclosed herein are effective in removing unwanted contaminants including, but not limited to, soils, particulates, allergens, living or non-living contaminants, harmful microorganisms, non-enveloped and enveloped viruses, spores, Gram negative and Gram positive bacteria, fungi, yeast, mold, and pathogenic microorganisms. In some embodiments, the hypohalite-based disinfecting compositions have efficacy against bacteria such as Staphylococcus aureus, methicillin-resistant S. aureus, Escherichia coli, Pseudomonas aeruginosa, Serratia marcescens, Tuberculosis, yeast such as Candida albicans and/or Candida auris, mold such as Aspergillus niger, fungi such as Trichophyton mentagrophytes, enveloped viruses including Influenza A virus and coronavirus, and non-enveloped viruses including Respiratory syncytial virus, Rhinovirus, Norovirus, Feline Calicivirus, and Hepatitis A. In some embodiments, the hypohalite-based disinfecting compositions have efficacy against bacterial spores in addition to Clostridium difficile, such as Bacillus anthracis.

The inventive hypohalite-based disinfecting compositions exhibit an improved (i.e., lower) surface tension in comparison to conventional bleach formulations. The surface tension of a liquid impacts the fluid coverage when applied to a surface. For example, fluid coverage may exhibit partial surface wetting, due to the formation of spherical droplets, or beads, spaced apart from one another on the surface. This phenomenon correlates to a high surface tension. Conversely, fluid coverage may exhibit complete wetting, through the formation of a thin, evenly spread liquid “film” that results from the coalescence of the liquid droplets. This phenomenon correlates to a low surface tension. In addition, a low surface tension provides better and faster wetting of organic pathogens and soil, which allows for faster kill times of the pathogens. It has been surprisingly found that intentionally blending two or more surfactants having different average tail lengths leads to the superior (i.e., lower) surface tension of the composition as compared to an otherwise identical composition comprising either one surfactant, or else two or more surfactants having identical average tail lengths.

In accordance with the present disclosure, the inventive hypohalite-based disinfecting compositions have a surface tension of 28 mN/m or less, including 27.8 mN/m or less, including 27.5 mN/m or less, including 27 mN/m or less, including 26.8 mN/m or less, including 26.5 mN/m or less, including a surface tension of from 24 to 28 mN/m, including from 24 to less than 28 mN/m, including from 25 to 28 mN/m, including from 25 to less than 28 mN/m, including from 24.5 to 27.5 mN/m, including from 25 to 27 mN/m.

Further improvements to the spreadability of the inventive hypohalite-based disinfecting composition result from the composition's reduced contact angle. The contact angle is a measurement of the angle of incidence between a surface and a liquid. For instance, water has a high contact angle and will sit as a droplet on a surface, while ethanol has a low contact angle and will quickly spread into cracks or crevices of the surface. A lower contact angle means that a formulation has superior wetting and spreading on a surface.

In accordance with the present disclosure, the inventive hypohalite-based disinfecting compositions have an equilibrium contact angle of less than 79° when applied to an exemplary hydrophobic polytetrafluoroethylene (PTFE) surface, including a contact angle of less than 77°, including a contact angle of less than 75°. In accordance with the present disclosure, the inventive hypohalite-based disinfecting compositions have an equilibrium contact angle of less than 65° when applied to an exemplary hydrophilic boron nitride surface, including a contact angle of less than 60°.

The hypohalite-based disinfecting compositions of the present invention may be employed on a wide variety of surfaces or substrates, including hard surfaces, soft surfaces, non-living (inanimate) surfaces, soil, porous, and non-porous surfaces. Embodiments of the present disclosure may be employed to disinfect or otherwise sanitize hard surfaces and inanimate objects. One surprising feature of the inventive hypohalite-based disinfecting compositions is the compatibility of the compositions with a number of diverse surfaces including, e.g., stainless steel. The inventive hypohalite-based disinfecting compositions exhibit lower residue, e.g., less visible streaking and/or spotting, than other comparable bleach compositions. Such residue, or film, left behind has been found undesirable by users. It is believed that the improved residue profile of the inventive hypohalite-based disinfecting compositions is attributable to the lower surface tension achieved by these compositions, as opposed to conventional bleach formulations.

The United States Environmental Protection Agency (EPA) publishes guidance regarding the human safety profile of disinfecting compositions under its “Design for the Environment” (“DfE”) policy. One feature of achieving the EPA's DfE classification is that a composition falls within the least hazardous classes (i.e., Category III or Category IV) of the EPA's “Acute Toxicity Category Hierarchy.” These toxicity categories are regulated under 40 CFR § 156.62 (Date: Jul. 1, 2014). One feature of the EPA toxicity categories is eye irritation. A product classified as Category III, upon exposure, exhibits “no corneal opacity; irritation reversible within 7 days,” and a product classified as category IV exhibits “no irritation.” In accordance with the present disclosure, the inventive hypohalite-based disinfecting compositions are categorized as at least Category III compositions, and in some embodiments, as Category IV compositions.

In accordance with the present disclosure, the hypohalite-based disinfecting compositions of the present invention may be formulated as liquids. For example, the hypohalite-based disinfecting compositions may be formulated as liquids that are poured, pumped, sprayed, dipped, rolled, or otherwise dispensed, including liquid concentrates and dilutable liquids. Other embodiments of the present disclosure include the hypohalite-based disinfecting compositions formulated as a spray. In some embodiments of the present disclosure, the hypohalite-based disinfecting compositions may be delivered in or on a wipe, i.e. a woven or nonwoven tissue, cloth, or substrate that is impregnated with a liquid and wiped over a surface.

In accordance with the present disclosure, the hypohalite-based disinfecting compositions of the present invention may be delivered in or on a wipe, such as, e.g., a pre-moistened wipe. Any wipe substrate compatible with the hypohalite ingredient may be used. In some embodiments, the wipe substrates comprise synthetic ingredients. In some embodiments, the wipe substrates comprise a single polymer or a mixture of two or more polymers. In some embodiments, the wipe substrates comprise polyethylene terephthalate (PET), polyester (PE), high density polyethylene (HDPE), polyvinyl chloride (PVC), chlorinated polyvinylidene chloride (CPVC), polyacrylamide (ACAM), polystyrene (PS), polypropylene (PP), polycarbonate (PC), polyaryletherketone (PAEK), poly(cyclohexylene dimethylene cyclohexanedicarboxylate) (PCCE), poly(cyclohexylene dimethylene terephthalate) (PCTA), poly(cyclohexylene dimethylene terephthalate) glycol (PCTG), polyetherimide (PEI), polyethersulfone (PES), poly(ethylene terephthalate) glycol (PETG), polyketone (PK), poly(oxymethylene); polyformaldehyde (POMF), poly(phenylene ether) (PPE), poly(phenylene sulfide) (PPS), poly(phenylene sulfone) (PPSU), syndiotactic polystyrene (syn-PS), polysulfone (PSU), polytetrafluoroethylene (PTFE), polyurethane (PUR), poly(vinylidene fluoride) (PVDF), polyamide thermoplastic elastomer (TPA), polybutylene (PB), polybutylene terephthalate (PBT), polypropylene terephthalate (PPT), polyethylene naphthalate (PEN), polyhydroxyalkanoate (PHA), poly(methyl)methacrylate (PMMA), polytrimethylene terephthalate (PTT), or combinations thereof. In some embodiments, the wipe substrates comprise polyethylene terephthalate (PET), polypropylene (PP), or combinations thereof. Due to incompatibility with the hypohalite ingredient, the wipe substrates may be devoid of cellulose or other naturally sourced materials. In accordance with the present disclosure, the ratio of hypohalite-based disinfecting composition to wipe substrate may be from 0.1:1 to 10:1 by weight, including from 2:1 to 6:1, including from 3:1 to 5:1.

The following paragraphs provide further non-limiting exemplary embodiments.

Paragraph 1. A disinfecting composition comprising: greater than 0.5 wt. % of a hypohalite ingredient, based upon the total weight of the disinfecting composition; and a surfactant blend comprising a first surfactant and a second surfactant, wherein the second surfactant has an average tail chain length value that is different than the first surfactant, wherein the disinfecting composition exhibits at least a 6-log reduction in C. diff within 2 minutes.

Paragraph 2. The disinfecting composition of paragraph 1, wherein the hypohalite ingredient comprises sodium hypochlorite.

Paragraph 3. The disinfecting composition of paragraphs 1 or 2, wherein the disinfecting composition comprises greater than 0.55 wt. % of the hypohalite ingredient, preferably greater than 0.6 wt. % of the hypohalite ingredient, preferably greater than 0.65 wt. % of the hypohalite ingredient.

Paragraph 4. The disinfecting composition of any one of paragraphs 1-3, wherein the disinfecting composition comprises 0.1 wt. % or less of the surfactant blend, based upon the total weight of the disinfecting composition, preferably from 0.005 to 0.1 wt. % of the surfactant blend, based upon the total weight of the disinfecting composition, preferably from 0.01 to 0.03 wt. % of the surfactant blend, based upon the total weight of the disinfecting composition.

Paragraph 5. The disinfecting composition of any one of paragraphs 1-4, wherein the weight ratio of the surfactant blend to the hypohalite ingredient, based on the total weight of the disinfecting composition, is below 1:1, preferably from 0.01:1 to 0.95:1.

Paragraph 6. The disinfecting composition of any one of paragraphs 1-5, wherein the second surfactant has a head group that is different than the first surfactant.

Paragraph 7. The disinfecting composition of any one of paragraphs 1-6, wherein the first surfactant has an average tail chain length of a C8 to C18 value and the second surfactant has an average tail chain length of a different C8 to C18 value than the first surfactant.

Paragraph 8. The disinfecting composition of any one of paragraphs 1-7, wherein the first surfactant has an average tail chain length of a C10 to C16 value and the second surfactant has an average tail chain length of a different C10 to C16 value than the first surfactant.

Paragraph 9. The disinfecting composition of any one of paragraphs 1-8, wherein the first surfactant has an average tail chain length of a C12 to C14 value and the second surfactant has an average tail chain length of a different C12 to C14 value than the first surfactant.

Paragraph 10. The disinfecting composition of any one of paragraphs 1-9, wherein the first surfactant has an average tail chain length of C12 and the second surfactant has an average tail chain length of C14.

Paragraph 11. The disinfecting composition of any one of paragraphs 1-10, wherein the first surfactant consists of an anionic surfactant and the second surfactant consists of a zwitterionic surfactant.

Paragraph 12. The disinfecting composition of paragraph 11, wherein the disinfecting composition comprises from 0.001 to 0.07 wt. % of the anionic surfactant, based upon the total weight of the disinfecting composition.

Paragraph 13. The disinfecting composition of paragraph 11 or 12, wherein the disinfecting composition comprises from 0.001 to 0.03 wt. % of the zwitterionic surfactant, based upon the total weight of the disinfecting composition.

Paragraph 14. The disinfecting composition of any one of paragraphs 11-13, wherein the molar ratio of anionic surfactant to zwitterionic surfactant is from 10:1 to 1:10, preferably from 7:1 to 1:7, preferably from 5:1 to 1:5, preferably from 3:1 to 1:3.

Paragraph 15. The disinfecting composition of any one of paragraphs 1-14, wherein the first surfactant consists of sodium lauryl sulfate and the second surfactant consists of myristamine oxide.

Paragraph 16. The disinfecting composition of paragraph 15, wherein the molar ratio of sodium lauryl sulfate to myristamine oxide is from 10:1 to 1:10, preferably from 3:1 to 1:3.

Paragraph 17. The disinfecting composition of any one of paragraphs 1-16, wherein the surfactant blend consists of the first surfactant and the second surfactant.

Paragraph 18. The disinfecting composition of any one of paragraphs 1-17, wherein the composition is devoid of cationic surfactants.

Paragraph 19. The disinfecting composition of any one of paragraphs 1-18, wherein the composition has a surface tension of 28 mN/m or less, preferably 27.5 mN/m or less, preferably of 27 mN/m or less.

Paragraph 20. The disinfecting composition of any one of paragraphs 1-19, wherein the disinfecting composition exhibits at least a 6-log reduction in C. diff. within less than 2 minutes, preferably within 110 seconds, preferably within 105 seconds.

Paragraph 21. The disinfecting composition of any one of paragraphs 1-20, wherein the disinfecting composition is provided in or on a wipe substrate.

Paragraph 22. A disinfecting composition comprising: greater than 0.5 wt. % of a hypohalite ingredient, based upon the total weight of the disinfecting composition; and a surfactant blend comprising a first surfactant and a second surfactant, wherein the second surfactant has an average tail chain length value that is different than the first surfactant, wherein the disinfecting composition exhibits a surface tension of 28 mN/m or less.

Paragraph 23. The disinfecting composition of paragraph 22, wherein the hypohalite ingredient comprises sodium hypochlorite.

Paragraph 24. The disinfecting composition of paragraph 22 or 23, wherein the disinfecting composition comprises greater than 0.55 wt. % of the hypohalite ingredient, preferably greater than 0.6 wt. % of the hypohalite ingredient, preferably greater than 0.65 wt. % of the hypohalite ingredient.

Paragraph 25. The disinfecting composition of any one of paragraphs 22-24, wherein the disinfecting composition comprises 0.1 wt. % or less of the surfactant blend, based upon the total weight of the disinfecting composition, preferably from 0.005 to 0.1 wt. % of the surfactant blend, based upon the total weight of the disinfecting composition, preferably from 0.01 to 0.03 wt. % of the surfactant blend, based upon the total weight of the disinfecting composition.

Paragraph 26. The disinfecting composition of any one of paragraphs 22-25, wherein the weight ratio of the surfactant blend to the hypohalite ingredient, based on the total weight of the disinfecting composition, is below 1:1, preferably from 0.01:1 to 0.95:1.

Paraph 27. The disinfecting composition of any one of paragraphs 22-26, wherein the second surfactant has a head group that is different than the first surfactant.

Paragraph 28. The disinfecting composition of any one of paragraphs 22-27, wherein the first surfactant has an average tail chain length of a C8 to C18 value and the second surfactant has an average tail chain length of a different C8 to C18 value than the first surfactant.

Paragraph 29. The disinfecting composition of any one of paragraphs 22-28, wherein the first surfactant has an average tail chain length of a C10 to C16 value and the second surfactant has an average tail chain length of a different C10 to C16 value than the first surfactant.

Paragraph 30. The disinfecting composition of any one of paragraphs 22-29, wherein the first surfactant has an average tail chain length of a C12 to C14 value and the second surfactant has an average tail chain length of a different C12 to C14 value than the first surfactant.

Paragraph 31. The disinfecting composition of any one of paragraphs 22-30, wherein the first surfactant has an average tail chain length of C12 and the second surfactant has an average tail chain length of C14.

Paragraph 32. The disinfecting composition of any one of paragraphs 22-31, wherein the first surfactant consists of an anionic surfactant and the second surfactant consists of a zwitterionic surfactant.

Paragraph 33. The disinfecting composition of paragraph 22, wherein the disinfecting composition comprises from 0.001 to 0.07 wt. % of the anionic surfactant, based upon the total weight of the disinfecting composition.

Paragraph 34. The disinfecting composition of paragraph 32 or 33, wherein the disinfecting composition comprises from 0.001 to 0.03 wt. % of the zwitterionic surfactant, based upon the total weight of the disinfecting composition.

Paragraph 35. The disinfecting composition of any one of paragraphs 32-34, wherein the molar ratio of anionic surfactant to zwitterionic surfactant is from 10:1 to 1:10, preferably from 7:1 to 1:7, preferably from 5:1 to 1:5, preferably from 3:1 to 1:3.

Paragraph 36. The disinfecting composition of any one of paragraphs 22-35, wherein the first surfactant consists of sodium lauryl sulfate and the second surfactant consists of myristamine oxide.

Paragraph 37. The disinfecting composition of paragraph 36, wherein the molar ratio of sodium lauryl sulfate to myristamine oxide is from 10:1 to 1:10, preferably from 3:1 to 1:3.

Paragraph 38. The disinfecting composition of any one of paragraphs 22-37, wherein the surfactant blend consists of the first surfactant and the second surfactant.

Paragraph 39. The disinfecting composition of any one of paragraphs 22-38, wherein the composition is devoid of cationic surfactants.

Paragraph 40. The disinfecting composition of any one of paragraphs 22-39, wherein the composition has a surface tension of 27.5 mN/m or less, preferably 27 mN/m or less.

Paragraph 41. The disinfecting composition of any one of paragraphs 22-40, wherein the disinfecting composition exhibits at least a 6-log reduction in C. diff within 2 minutes, preferably less than 2 minutes, preferably 110 seconds, preferably 105 seconds.

Paragraph 42. The disinfecting composition of any one of paragraphs 22-41, wherein the disinfecting composition is provided in or on a wipe substrate.

Paragraph 43. A disinfecting composition comprising: greater than 5,000 ppm of sodium hypochlorite; and less than 1,000 ppm of a surfactant blend comprising a first surfactant and a second surfactant, wherein the second surfactant has an average tail chain length value that is different than the first surfactant, wherein the second surfactant has a head group that is different than the first surfactant, wherein the disinfecting composition has a surface tension of 28 mN/m or less, and wherein the disinfecting composition exhibits at least a 6-log reduction in C. diff within 2 minutes.

Paragraph 44. The disinfecting composition of paragraph 43, wherein the disinfecting composition comprises greater than 5,500 ppm of the hypohalite ingredient, preferably greater than 6,000 ppm of the hypohalite ingredient, preferably greater than 6,500 ppm of the hypohalite ingredient.

Paragraph 45. The disinfecting composition of paragraph 43 or 44, wherein the disinfecting composition comprises from 100 to 300 ppm of the surfactant blend.

Paragraph 46. The disinfecting composition of any one of paragraphs 43-45, wherein the weight ratio of the surfactant blend to the hypohalite ingredient, based on the total weight of the disinfecting composition, is below 1:1, preferably from 0.01:1 to 0.95:1, preferably from 0.01:1 to 0.5:1.

Paragraph 47. The disinfecting composition of any one of paragraphs 43-46, wherein the first surfactant has an average tail chain length of a C8 to C18 value and the second surfactant has an average tail chain length of a different C8 to C18 value than the first surfactant.

Paragraph 48. The disinfecting composition of any one of paragraphs 43-47, wherein the first surfactant has an average tail chain length of a C10 to C16 value and the second surfactant has an average tail chain length of a different C10 to C16 value than the first surfactant.

Paragraph 49. The disinfecting composition of any one of paragraphs 43-48, wherein the first surfactant has an average tail chain length of a C12 to C14 value and the second surfactant has an average tail chain length of a different C12 to C14 value than the first surfactant.

Paragraph 50. The disinfecting composition of any one of paragraphs 43-49, wherein the first surfactant has an average tail chain length of C12 and the second surfactant has an average tail chain length of C14.

Paragraph 51. The disinfecting composition of any one of paragraphs 43-50, wherein the first surfactant consists of an anionic surfactant and the second surfactant consists of a zwitterionic surfactant.

Paragraph 52. The disinfecting composition of paragraph 51, wherein the disinfecting composition comprises from 10 to 700 ppm of the anionic surfactant.

Paragraph 53. The disinfecting composition of paragraph 51 or 52, wherein the disinfecting composition comprises from 10 to 300 ppm of the zwitterionic surfactant.

Paragraph 54. The disinfecting composition of any one of paragraphs 51-53, wherein the molar ratio of anionic surfactant to zwitterionic surfactant is from 10:1 to 1:10, preferably from 7:1 to 1:7, preferably from 5:1 to 1:5, preferably from 3:1 to 1:3.

Paragraph 55. The disinfecting composition of any one of paragraphs 43-54, wherein the first surfactant consists of sodium lauryl sulfate and the second surfactant consists of myristamine oxide.

Paragraph 56. The disinfecting composition of paragraph 55, wherein the molar ratio of sodium lauryl sulfate to myristamine oxide is from 10:1 to 1:10, preferably from 3:1 to 1:3.

Paragraph 57. The disinfecting composition of any one of paragraphs 43-56, wherein the surfactant blend consists of the first surfactant and the second surfactant.

Paragraph 58. The disinfecting composition of any one of paragraphs 43-57, wherein the composition is devoid of cationic surfactants.

Paragraph 59. The disinfecting composition of any one of paragraphs 43-58, wherein the composition has a surface tension of 27.5 mN/m or less, preferably 27 mN/m or less.

Paragraph 60. The disinfecting composition of any one of paragraphs 43-59, wherein the disinfecting composition exhibits at least a 6-log reduction in C. diff within 110 seconds, preferably within 105 seconds.

Paragraph 61. The disinfecting composition of any one of paragraphs 43-60, wherein the disinfecting composition is provided in or on a wipe substrate.

The general inventive concepts have been described above both generally and with regard to various specific exemplary embodiments. Although the general inventive concepts have been set forth in what are believed to be exemplary illustrative embodiments, a wide variety of alternatives will be apparent to those of skill in the art from reading this disclosure. The general inventive concepts are not otherwise limited, except for those instances when presented in specific claims.

### EXAMPLES

The following examples are included for the purposes of illustration, and do not limit the scope of the general inventive concepts described herein.

### Example 1

The efficacy of various hypohalite-based disinfecting compositions against C. difficile spores was observed, according to the EPA “Standard Operating Procedure for Quantitative Disk Carrier Test Method (QCT-2) Modified for Testing Antimicrobial Products Against Spores of Clostridium difficile (ATCC 43598) on Inanimate, Hard, Non-porous Surfaces” (SOP Number: MB-31-03) (Date Revised: Jun. 12, 2014). Four exemplary formulations were prepared having identical compositions apart from the surfactant blend. Specifically, varying blends of myristamine oxide (“MO”), sodium lauryl sulfate (“SLS”), and lauramine oxide (“LO”) were observed, as designated by inclusion (“Y” yes or “N” no) in Table 1. For each sample, the total concentration of surfactant was the same, at 300 ppm total surfactant, with only the noted variations in type of surfactant.

The criterion for success of the compositions (i.e., a “pass” versus a “fail”) was at least a 6-log average reduction in C. difficile within 2 minutes (120 seconds) or less.

The efficacy against C. difficile spores for each of the four samples at 2 minutes contact time is shown in Table 1.

TABLE 1
C. difficile Micro-Efficacy with a 2-Minute Contact Time

| | | | | | | Av- | | | |
|---|---|---|---|---|---|---|---|---|---|
| | | | | | | erage | | | |
| | | | | | | Log | | | |
| | | Sodium | | | | Re- | | | |
| | | Hypo- | Surfactant | | | duction | | | |
| | De- | chlorite | Blend | | | at 120 | | | Out- |
| | scription | (wt. %) | MO | SLS | LO | seconds | Stdev | pH | come |
| 1 | SLS/LO | 0.55% | N | Y | Y | 4.68 | 1.82 | 10.9 | Fail |
| | formula | | | | | | | | |
| 2 | SLS only | 0.55% | N | Y | N | 4.22 | 0.36 | 11.0 | Fail |
| | formula | | | | | | | | |
| 3 | MO only | 0.55% | Y | N | N | 5.40 | 0.36 | 11.0 | Fail |
| | formula | | | | | | | | |
| 4 | SLS/MO | 0.55% | Y | Y | N | 6.25 | 0.11 | 11.0 | Pass |
| | formula | | | | | | | | |

As shown in Table 1, only Sample 4, in which the surfactant blend comprised the combination of sodium lauryl sulfate, having a C12 average tail length, and myristamine oxide, having a C14 average tail length, in accordance with the instant disclosure met the success criteria (i.e., at least a 6-log average reduction in C. difficile within 2 minutes).

### Example 2

The efficacy of a hypohalite-based disinfecting composition in accordance with the present disclosure against C. difficile spores was observed, under the same operating conditions and testing procedure as Example 1. The sample comprised 0.65 wt. % sodium hypochlorite and 0.03 wt. % (300 ppm) of a surfactant blend, based upon to the total weight of the hypohalite -based disinfecting composition. The surfactant blend consisted of myristamine oxide (“MO”) and sodium lauryl sulfate (“SLS”).

Upon testing in accordance with the EPA “Standard Operating Procedure for Quantitative Disk Carrier Test Method (QCT-2) Modified for Testing Antimicrobial Products Against Spores of Clostridium difficile (ATCC 43598) on Inanimate, Hard, Non-porous Surfaces” (SOP Number: MB-31-03) (Date Revised: Jun. 12, 2014), the exemplary sample provided a 6.16 average log reduction in C. difficile within 80 seconds.

### Example 3

In accordance with the present disclosure, it was found that intentionally blending two or more surfactants having different average tail lengths leads to a superior (i.e., lower) surface tension of a hypohalite-based disinfecting composition. Various combinations of sodium lauryl sulfate, having a C12 average tail length, and myristamine oxide, having a C14 average tail length were tested with respect to the surface tension of hypohalite-based disinfecting compositions comprising the surfactant blend.

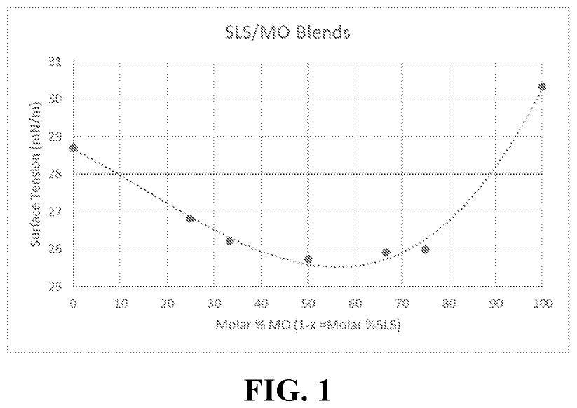

FIG. 1 is a line plot showing the surface tension of otherwise identical hypohalite-based disinfecting compositions comprising varying levels of SLS/MO surfactant blends. As shown in FIG. 1, a molar ratio of sodium lauryl sulfate to myristamine oxide (i.e., [SLS]:[MO]) of from 10:1 to 1:10 met the success criteria (i.e., a surface tension of 28 mN/m or less).

### Example 4

The spreadability of a liquid composition can be measured by the contact angle of the composition. Specifically, the contact angle is a measurement of the angle of incidence between a surface and a liquid. The contact angles of six hypohalite-based disinfecting compositions in wipe form were observed, in accordance with the static sessile drop method on two cleaned and heat-treated surfaces with known and well-defined surface properties. Specifically, the contact angles of three hypohalite-based disinfecting wipes in accordance with the instant disclosure were compared to the contact angles of three commercially-available bleach wipes, both on an exemplary hydrophobic polytetrafluoroethylene (PTFE) surface and on an exemplary hydrophilic boron nitride surface.

A lower contact angle means that a formulation has superior wetting and spreading on a surface. As shown in Tables 2 and 3, the three hypohalite-based disinfecting wipes in accordance with the instant disclosure exhibited a significantly improved contact angle as compared to commercially-available bleach wipes.

TABLE 2
Contact Angle On Hydrophobic Surface (PTFE)
PTFE Contact Angles—Bleach Formulations

| | | | | Com- | Com- | Com- |
|---|---|---|---|---|---|---|
| | | | | petitor | petitor | petitor |
| | Example | Example | Example | A | B | C |
| | 1 | 2 | 3 | (de- | (de- | (de- |
| Test | (degrees) | (degrees) | (degrees) | grees) | grees) | grees) |
| 1 | 73.5 | 73.0 | 74.3 | 79.5 | 98.3 | 92.1 |
| 2 | 73.5 | 73.0 | 74.6 | 79.5 | 98.1 | 92.1 |
| 3 | 73.3 | 72.9 | 74.5 | 79.2 | 98.0 | 92.4 |
| 4 | 73.4 | 72.9 | 74.6 | 79.6 | 98.2 | 92.1 |
| 5 | 73.3 | 73.0 | 74.5 | 79.4 | 98.1 | 92.3 |
| Av- | 73.4 | 73.0 | 74.5 | 79.4 | 98.1 | 92.2 |
| erage | | | | | | |
| Std. | 0.1 | 0.1 | 0.1 | 0.2 | 0.1 | 0.1 |
| Dev. | | | | | | |

TABLE 3
Contact Angle On Hydrophilic Surface (Boron Nitride)
Boron Nitride Contact Angles—Bleach Formulations

| | | | | Com- | Com- | Com- |
|---|---|---|---|---|---|---|
| | | | | petitor | petitor | petitor |
| | Example | Example | Example | A | B | C |
| | 1 | 2 | 3 | (de- | (de- | (de- |
| Test | (degrees) | (degrees) | (degrees) | grees) | grees) | grees) |
| 1 | 57.0 | 57.2 | 57.0 | 65.4 | 88.4 | 81.5 |
| 2 | 56.6 | 57.4 | 57.0 | 65.5 | 88.3 | 81.2 |
| 3 | 56.9 | 57.2 | 56.7 | 65.4 | 88.5 | 81.1 |
| 4 | 56.7 | 57.2 | 56.6 | 65.5 | 88.5 | 81.4 |
| 5 | 56.8 | 57.4 | 56.8 | 65.7 | 88.7 | 81.1 |
| Av- | 56.8 | 57.3 | 56.8 | 65.5 | 88.5 | 81.3 |
| erage | | | | | | |
| Std. | 0.2 | 0.1 | 0.2 | 0.1 | 0.1 | 0.2 |
| Dev. | | | | | | |

What is claimed is:

1. A disinfecting composition comprising:
greater than 0.5 wt. % of a hypohalite ingredient, based upon the total weight of the disinfecting composition; and
a surfactant blend comprising a first surfactant and a second surfactant, wherein the second surfactant has an average tail chain length value that is different than the first surfactant,
wherein the disinfecting composition exhibits at least a 6-log reduction in C. diff within 2 minutes.

2. The disinfecting composition of claim 1, wherein the disinfecting composition comprises greater than 0.65 wt. % of the hypohalite ingredient.

3. The disinfecting composition of claim 1, wherein the disinfecting composition comprises from 0.005 to 0.1 wt. % of the surfactant blend, based upon the total weight of the disinfecting composition.

4. The disinfecting composition of claim 1, wherein the weight ratio of the surfactant blend to the hypohalite ingredient, based on the total weight of the disinfecting composition, is from 0.01:1 to 0.95:1.

5. The disinfecting composition of claim 1, wherein the second surfactant has a head group that is different than the first surfactant.

6. The disinfecting composition of claim 1, wherein the first surfactant has an average tail chain length of a C10 to C16 value and the second surfactant has an average tail chain length of a different C10 to C16 value than the first surfactant.

7. The disinfecting composition of claim 1, wherein the first surfactant has an average tail chain length of a C12 to C14 value and the second surfactant has an average tail chain length of a different C12 to C14 value than the first surfactant.

8. The disinfecting composition of claim 1, wherein the first surfactant has an average tail chain length of C12 and the second surfactant has an average tail chain length of C14.

9. The disinfecting composition of claim 1, wherein the first surfactant consists of an anionic surfactant and the second surfactant consists of a zwitterionic surfactant.

10. The disinfecting composition of claim 9, wherein the molar ratio of anionic surfactant to zwitterionic surfactant is from 10:1 to 1:10.

11. The disinfecting composition of claim 1, wherein the first surfactant consists of sodium lauryl sulfate and the second surfactant consists of myristamine oxide.

12. The disinfecting composition of claim 11, wherein the molar ratio of sodium lauryl sulfate to myristamine oxide is from 3:1 to 1:3.

13. The disinfecting composition of claim 1, wherein the surfactant blend consists of the first surfactant and the second surfactant.

14. The disinfecting composition of claim 1, wherein the composition is devoid of cationic surfactants.

15. The disinfecting composition of claim 1, wherein the composition has a surface tension of 28 mN/m or less.

16. The disinfecting composition of claim 1, wherein the disinfecting composition exhibits at least a 6-log reduction in C. diff within 110 seconds.

17. A disinfecting composition comprising:
greater than 0.5 wt. % of a hypohalite ingredient, based upon the total weight of the disinfecting composition; and
a surfactant blend comprising a first surfactant and a second surfactant, wherein the second surfactant has an average tail chain length value that is different than the first surfactant,
wherein the disinfecting composition exhibits a surface tension of 28 mN/m or less.

18. The disinfecting composition of claim 17, wherein the second surfactant has a head group that is different than the first surfactant.

19. The disinfecting composition of claim 17, wherein the first surfactant consists of an anionic surfactant and the second surfactant consists of a zwitterionic surfactant.

20. A disinfecting composition comprising:
greater than 5,000 ppm of sodium hypochlorite; and
less than 1,000 ppm of a surfactant blend comprising a first surfactant and a second surfactant,
wherein the second surfactant has an average tail chain length value that is different than the first surfactant,
wherein the second surfactant has a head group that is different than the first surfactant,
wherein the disinfecting composition has a surface tension of 28 mN/m or less, and
wherein the disinfecting composition exhibits at least a 6-log reduction in C. diff within 2 minutes.
